(19) United States
(12) Patent Application Publication
(10) Pub. No.: US 2006/0006269 A1
(43) Pub. Date: Jan. 12, 2006

(54) Safety belt system for a motor vehicle and a method for controlling an electric motor in a safety belt system

(75) Inventor: Franz Wier, Goeggingen (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive GmbH

(21) Appl. No.: 11/177,468

(22) Filed: Jul. 8, 2005

(30) Foreign Application Priority Data
Jul. 9, 2004 (DE) 10 2004 033 368.8

(51) Int. Cl. B60R 22/46

(52) U.S. Cl. 242/374

(57) ABSTRACT

A safety belt system for a motor vehicle includes a belt retractor (10). The belt retractor (10) includes a belt spool (14) and an electric motor (18). The belt spool (14) can be rotated by the electric motor (18) at least in a belt webbing winding direction. According to a first aspect, the electric motor (18) is coupled to the belt spool (14) without a clutch, and the belt retractor (10) further includes a retraction spring (24) which pre-tensions the belt spool (14) in the belt webbing winding direction. The pre-tensioning force of the retraction spring (24) is restricted to functionality in terms of comfort. According to a second aspect, the electric motor (18) is controlled by a control unit (20) coupled to the braking system of the vehicle. A method for controlling an electric motor (18) in a safety belt system makes provision that the electric motor (18) is activated in response to a braking process.

### TECHNICAL FIELD

The invention relates to a safety belt system for a motor vehicle, in particular to a safety belt system comprising a belt retractor which includes a belt spool and an electric motor, the belt spool being able to be turned by the electric motor at least in a belt webbing winding direction. The invention further relates to a method for controlling an electric motor in a safety belt system.

### BACKGROUND OF THE INVENTION

In conventional safety belt systems, belt retractors with retraction springs are used which are able to completely wind up again the belt webbing withdrawn by an occupant, after he has put on the safety belt. The strong pre-stressing force of the retraction spring in the belt webbing winding direction leads, however, to restrictions in comfort in the use of the safety belt, because the safety belt must be withdrawn contrary to the resistance of the retraction spring and is felt in an unpleasant manner after the belt is put on by the occupant.

Safety belt systems with powerful electric motors and variable electronic controls are also known, which in a so-called “pre-crash” situation offer a high tensioning power for a pre-stressing of the belt webbing which is possibly placed only loosely against the occupant's body. The motors of such systems are, however, large, heavy and expensive, owing to the high requirements.

There is a need for a safety belt system with improved comfort.

### BRIEF SUMMARY OF THE INVENTION

According to a first aspect of the invention, a safety belt system for a motor vehicle comprises a safety belt and a belt retractor, the belt retractor including a belt spool and an electric motor, the belt spool being able to be rotated by the electric motor at least in a belt webbing winding direction, wherein the electric motor being coupled to the belt spool without a clutch, the belt retractor further including a retraction spring which pre-stresses the belt spool in the belt webbing winding direction, the pre-tensioning force of the retraction spring being restricted to functionality in terms of comfort.

According to a second aspect of the invention, a safety belt system comprises a safety belt and a belt retractor, the belt retractor including a belt spool and an electric motor, the belt spool being able to be rotated by the electric motor at least in a belt webbing winding direction, wherein the electric motor being controlled by a control unit coupled to a braking system of the vehicle. The safety belt system according to the invention operates successfully with an electric motor of weaker design, and nevertheless provides as optimum preconditions as possible for a belt tensioning following a pre-tensioning. The invention is based on the finding that an accident is almost always preceded by an actuation of the brake of the vehicle. The connection to the braking system provides for a pre-tensioning on every actuation of the brake and hence provides for an optimum position of the safety belt (and indirectly also of the occupant) for a belt tensioning. As the electric motor is able to be activated by the occupant through an actuation of the brake, a retraction spring can either by dispensed with entirely, or it can be designed to be so weak that the comfort restrictions are reduced to a minimum. As the belt webbing winding is brought about by the electric motor, a belt webbing having more pleasant haptic characteristics can be used, which with the use of a conventional retraction spring would lead to distinct impairments in belt webbing winding. When using a control which can operate the electric motor in a currentless state with the brake not actuated, or in other situations in which a belt webbing winding is not suitable, a coupling for a selective drive of the belt spool is not necessary. Rather, the belt retractor is able at any time to tension the belt webbing in a braking process without prior coupling of the motor.

For the coupling of the electric motor to the belt spool, preferably a gear is provided which comprises a pinion driven by the electric motor and a toothed wheel coupled to the belt spool. With a transmission ratio of the gear in the range of approximately 30:1 to approximately 60:1, a relatively weak and favorably priced motor is sufficient in order to tension the belt webbing so taut that any belt slack is reduced to a sufficient extent.

A preferred embodiment of the invention provides for a retraction spring, arranged in the belt retractor, which pre-stresses the belt spool in the belt webbing winding direction. As already mentioned, for reasons of comfort, the retraction spring can be designed to less than two or even to less than one revolution up to reaching its maximum tension.

A particularly narrow structural form of the belt retractor can be realized in that the retraction spring is accommodated in the toothed wheel. The belt retractor is therefore also suitable for a safety belt system which is integrated in a vehicle seat.

The invention also provides a method for controlling the electric motor in a safety belt system according to the invention, in accordance with which the electric motor is activated in response to a braking process.

### BRIEF DESCRIPTION OF THE DRAWINGS

FIG. 1 shows a side view of a belt retractor for a safety belt system according to the invention in accordance with a first embodiment;

FIG. 2 shows an end face view of the belt retractor of FIG. 1; and

FIG. 3 shows a side view of a belt retractor for a safety belt system according to the invention in accordance with a second embodiment.

### DETAILED DESCRIPTION OF THE PREFFERED EMBODIMENTS

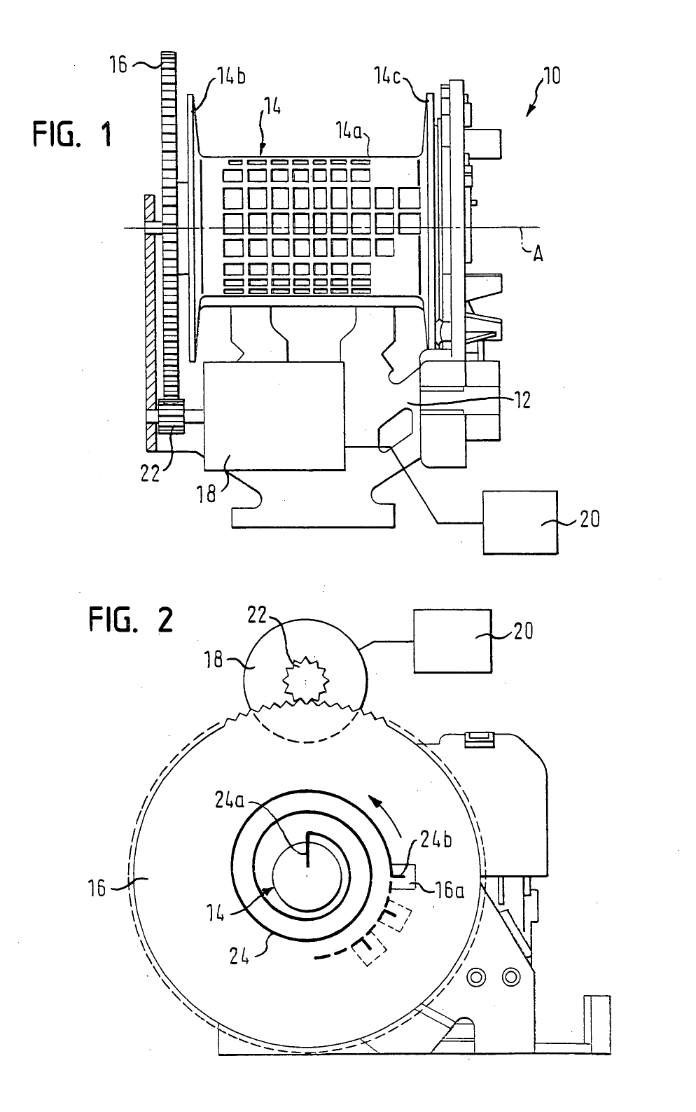

In FIG. 1 a belt retractor 10 is illustrated with a belt spool 14 mounted in a housing 12 for rotation about an axis A. The belt spool 14 has a winding section 14a which is delimited by two margin sections 14b and 14c. A toothed wheel 16, likewise rotatable about the axis A, is coupled to the belt spool 14 by means of a retraction spring explained in further detail below.

The belt retractor 10 further comprises a simple electric motor 18, which is controlled by means of a control unit 20 (only illustrated symbolically), and can be operated in two directions of rotation. The control unit 20 is, in turn, coupled to the braking system of the vehicle and can evaluate signals which, for example, are generated by a brake assistant, a brake booster or simply by an actuation of the brake pedal of the vehicle, for a control of the electric motor 18.

The electric motor 18 is fastened between two side parts of the housing 12 and drives a pinion 22 which meshes with the toothed wheel 16 so that the belt spool 14 can be turned by the electric motor 18 both in the belt webbing winding direction and also in the belt webbing withdrawal direction. The pinion 22 and the toothed wheel 16 form a gear which has a transmission ratio of 30:1 or 60:1, for example. No clutch is provided between the electric motor 18 and the belt spool 14, i.e. the electric motor 18 can drive the belt spool 14 directly by means of the gear with no time delay.

In FIG. 2 it can be seen that the retraction spring 24, constructed as a spiral spring, is accommodated in the toothed wheel 16. The inner end 24a of the retraction spring 24 is coupled to the belt spool 14, the outer end 24b is constructed as a tappet and engages into a recess 16a on the toothed wheel 16. Upon a rotation of the belt spool 14 in the belt webbing withdrawal direction, the retraction spring 24 provides for a pre-stressing of the belt spool 14 against the toothed wheel 16 in the belt webbing winding direction.

The retraction spring 24 is designed so as to be relatively weak, i.e. the spring force at maximum tension of the retraction spring 24 is very low compared with conventional retraction springs. After a rotation of the inner end 24a of the retraction spring 24, which is coupled to the belt spool 14, by a maximum of two revolutions in the belt webbing withdrawal direction, preferably after approximately 700 degrees, the outer end 24b of the retraction spring 24 entrains the toothed wheel 16 if the electric motor 18 is off (i.e. currentless). According to another variant of the belt retractor, the entrainment already takes place after a maximum of one revolution, preferably after approximately 350 degrees. In particular, the retraction spring 24 is designed such that it can not completely wind up the safety belt with the insert tongue in the non-buckled state; the insert tongue on the safety belt may be lifted by a maximum of 500 mm from the floor of the vehicle interior.

The mode of operation of the safety belt system according to the invention is described below, in particular with regard to how the electric motor 18 is controlled according to the invention.

Before a vehicle occupant puts on the belt, the electric motor 18 is currentless, so that it does not offer a significant rotational resistance either to a rotation in the belt webbing withdrawal direction or in the belt webbing winding direction. When the occupant withdraws a length of belt webbing, the belt spool 14 and thereby also the inner end 24a of the retraction spring 24 rotate in the belt webbing withdrawal direction. After just under two revolutions, the tensioned retraction spring 24 entrains with its outer end 24b the toothed wheel 16, whereby the currentless electric motor 18 is co-rotated on further belt webbing withdrawal. Owing to the low resistance of the retraction spring 24 and the electric motor 18, which is in a currentless state, the belt webbing withdrawal is possible in a very comfortable manner.

After the vehicle occupant has put on the belt, the retraction spring 24 relaxes and in so doing turns the belt spool 14 by just under two revolutions back in the belt webbing winding direction. Thereby, the belt webbing is placed loosely against the body of the occupant. If the occupant bends forward, the belt webbing follows this movement, i.e. belt webbing is withdrawn. For this, the occupant must merely overcome the low pre-stressing force of the retraction spring 24, which represents a distinct advantage in terms of comfort compared with safety belt systems with conventional retraction springs. This applies in particular to the case of a safety belt with an inflatable section, which basically offers less wearing comfort than a conventional safety belt and, owing to the higher weight, would require an even stronger retraction spring in a conventional safety belt system without an electric motor.

In a braking process, the control unit 20 activates the electric motor 18, so that the belt spool 14 is turned in the belt webbing winding direction and thereby the belt webbing is tensioned. As the belt webbing is already pre-tensioned by the retraction spring 24 in the belt webbing winding direction, on a rotation of the electric motor 18 the belt webbing is immediately wound. The control unit 20 sets the output of the electric motor 18 depending on the braking force. For example, via the pedal travel of the brake pedal, a potentiometer can be used to determine the current consumption of the electric motor 18. The control unit 20 makes provision that the electric motor 18 is operated with maximum output at a full braking, in order to achieve a maximum belt tension. Thereby, optimum preconditions for a subsequent belt tensioning are provided, when an impact of the vehicle actually occurs.

After a braking process, the electric motor 18 assumes the currentless state again. By bending forward, the occupant can withdraw belt webbing again, which is then placed loosely against the occupant's body again by the pre-stressing force of the retraction spring 24.

The controlling of the electric motor 18 makes possible a tensioning and relaxing of the belt webbing which can be repeated as often as desired, through actuation and releasing of the brake pedal and subsequent bending forward of the occupant, respectively.

In the case of a longer lasting actuation of the brake, e.g. at traffic lights or on an inclined road, the output of the electric motor 18 is reduced, or the electric motor 18 is switched off. The exceeding of a predetermined time duration serves as criterion.

The electric motor 18 is also switched off in situations in which the resistance against a rotation of the electric motor 18 exceeds a predetermined value or if the electric motor 18 is operated longer than a predetermined time duration.

When the occupant takes off the safety belt, owing to the weak design of the retraction spring 24 only a portion of the belt webbing is wound onto the belt spool 14. Through an actuation of the brake pedal, the belt webbing can be fully wound.

An enhanced control provides for an automatic winding of the belt webbing after the safety belt has been taken off. In this case, the control unit 20 activates the electric motor 18 in response to a signal which is triggered by an opening of the belt buckle of the safety belt system or by the opening of the associated door of the vehicle. Such an activation can also take place with a time delay. After a predetermined time duration, e.g. 5 seconds, the control 20 switches the electric motor 18 off again.

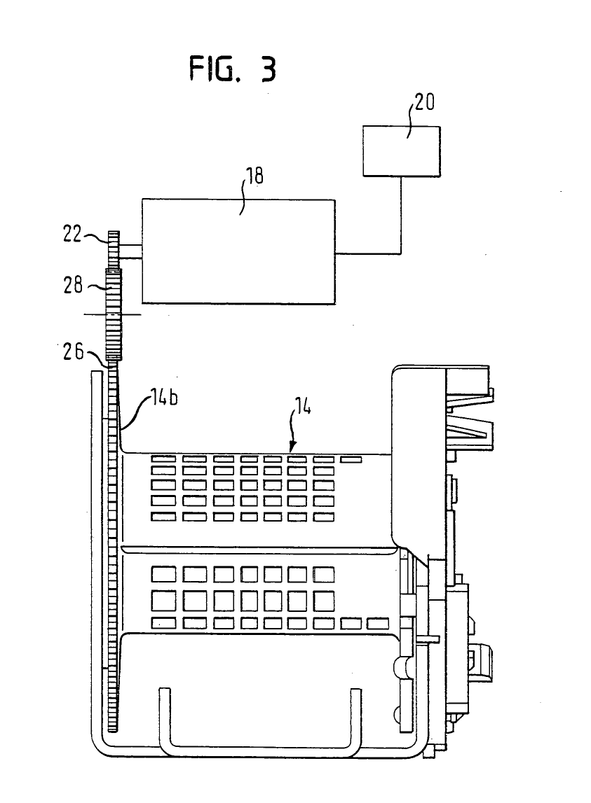

An alternative embodiment of the safety belt system according to the invention operates successfully with a belt retractor without a retraction spring. In this embodiment, the toothed wheel 16 can be constructed for example in one piece with the belt spool 14, or, as shown in FIG. 3, instead of a separate toothed wheel, outer teeth 26 can be provided, formed directly integrally with one of the margin sections 14a and 14b of the belt spool 14. The gear formed between the electric motor 18 and the belt spool 14 can also have one or more additional pinions or toothed wheels 28 between the pinion 22 and the toothed margin section 14b. In this embodiment, the supporting force in the belt webbing winding direction is provided solely by the electric motor 18.

1. A safety belt system for a motor vehicle, the safety belt system comprising a safety belt and a belt retractor, the belt retractor including a belt spool and an electric motor, the belt spool being able to be rotated by the electric motor at least in a belt webbing winding direction, wherein the electric motor being coupled to the belt spool without a clutch, the belt retractor further including a retraction spring which pre-stresses the belt spool in the belt webbing winding direction, the pre-tensioning force of the retraction spring being restricted to functionality in terms of comfort.

2. A safety belt system for a motor vehicle, the safety belt system comprising a safety belt and a belt retractor, the belt retractor including a belt spool and an electric motor, the belt spool being able to be rotated by the electric motor at least in a belt webbing winding direction, wherein the electric motor being controlled by a control unit coupled to a braking system of the vehicle.

3. The safety belt system according to claim 1, wherein the control unit comprises a control member dependent on a pedal travel of a brake pedal, in particular a potentiometer, which directly or indirectly determines the current consumption of the electric motor.

4. The safety belt system according to claim 1, wherein for coupling the electric motor to the belt spool a gear is provided, which comprises a pinion driven by the electric motor and a toothed wheel coupled to the belt spool.

5. The safety belt system according to claim 4, wherein the gear has a transmission ratio in the range of approximately 30:1 to approximately 60:1.

6. The safety belt system according to claim 2, wherein a retraction spring is arranged in the belt retractor, which pre-stresses the belt spool in the belt webbing winding direction.

7. The safety belt system according to claim 1, wherein the retraction spring is designed such that it can not completely wind up the safety belt with an insert tongue in the non-buckled state.

8. The safety belt system according to claim 7, wherein the retraction spring is designed such that it can lift the insert tongue on the safety belt by a maximum of 500 mm from the floor of the vehicle interior.

9. The safety belt system according to claim 1, wherein for coupling the electric motor to the belt spool a gear is provided, which comprises a pinion driven by the electric motor and a toothed wheel coupled to the belt spool, a first end of the retraction spring being coupled to the belt spool and a second end of the retraction spring being coupled to the toothed wheel.

10. The safety belt system according to claim 9, wherein the second end of the retraction spring comprises a tappet and engages the toothed wheel at least indirectly.

11. The safety belt system according to claim 9, wherein the retraction spring is designed so that it is tensioned to a maximum after a rotation of the first end relative to the second end by a maximum of two revolutions, preferably after a rotation through approximately 700 degrees.

12. The safety belt system according to claim 9, wherein the retraction spring is designed so that it is tensioned to a maximum after a rotation of the first end relative to the second end by a maximum of one revolution, preferably after a rotation through approximately 350 degrees.

13. The safety belt system according to claim 0.9, wherein the retraction spring is accommodated in the toothed wheel.

14. The safety belt system according to claim 4, wherein the toothed wheel is constructed in one piece with the belt spool or that teeth are formed integrally with the belt spool.

15. The safety belt system according to claim 1, wherein the belt spool can also be turned by the electric motor in a belt webbing withdrawal direction.

16. The safety belt system according to claim 1, wherein the safety belt has an inflatable section.

17. A method for controlling an electric motor in a safety belt system, the safety belt system comprising a safety belt and a belt retractor, the belt spool being able to be rotated by the electric motor at least in a belt webbing winding direction, wherein the electric motor is activated in response to a braking process.

18. The method according to claim 17, wherein the output of the electric motor is set dependent on the braking force.

19. The method according to claim 18, wherein the electric motor is operated with maximum power at a full braking.

20. The method according to claim 17, wherein the power of the electric motor is reduced or the electric motor is switched off, when the brake pedal of the vehicle is actuated longer than a predetermined duration.

21. The method according to claim 17, wherein the electric motor is in a currentless state when the resistance against a rotation of the electric motor exceeds a predetermined value.

22. The method according to claim 17, wherein the electric motor is controlled in response to a signal which is triggered by an opening of a belt buckle or by the opening of a door of the vehicle.

23. The method according to claim 17, wherein the electric motor is switched off automatically after a predetermined operating period.
